(19) United States
(12) Patent Application Publication
(10) Pub. No.: US 2025/0271922 A1
(43) Pub. Date: Aug. 28, 2025

(54) INPUT/OUTPUT MODULE INTERFACE WITH POWER SAVING MODE

(71) Applicant: WAGO Verwaltungsgesellschaft mbH, Minden (DE)

(72) Inventors: Jonathan JANSEN, Porta Westfalica (DE); Jan-Philipp JANSEN, Hille (DE); Timo Manuel HOLZKAMP, Extertal (DE)

(73) Assignee: WAGO Verwaltungsgesellschaft mbH, Minden (DE)

(21) Appl. No.: 19/064,986

(22) Filed: Feb. 27, 2025

(30) Foreign Application Priority Data
Feb. 27, 2024 (DE) 10 2024 105 515.4

(51) Int. Cl. G06F 1/3234

(52) U.S. Cl. CPC G06F 1/3278

(57) ABSTRACT

An input/output module that comprises a first interface and a second interface. The I/O module sends first process data to a control module via the first interface and/or receives second process data from the control module via the first interface. The I/O module also sends a first signal indicating availability of the first process data to the control module via the second interface and/or receives a second signal indicating availability of the second process data from the control module via the second interface. The I/O module is further configured to cause the first interface to transition from a power saving mode, in which the first interface is not ready to receive data, to a communication mode, in which the first interface is ready to receive data, when the first interface is in the power saving mode and the second signal is received via the second interface.

This nonprovisional application claims priority under 35 U.S.C. § 119(a) to German Patent Application No. 10 2024 105 515.4, which was filed in Germany on Feb. 27, 2024, and which is herein incorporated by reference.

### BACKGROUND OF THE INVENTION

### Field of the Invention

The present invention relates to the exchange of data between an input/output (I/O) module and a control module. In particular, the present invention relates to reducing power consumption when exchanging data between the I/O module and the control module.

### Description of the Background Art

I/O modules are often connected to a network via wired interfaces such as local bus and field bus interfaces and can send or receive data via these wired interfaces. During phases in which no communication takes place, the interfaces still consume energy when monitoring the transmission lines.

### SUMMARY OF THE INVENTION

It is therefore an object of the invention to provide an I/O module interface with a power saving mode.

In an example, an I/O module is provided that comprises a first interface, wherein the I/O module is configured to send first process data to a control module via the first interface and/or to receive second process data from the control module via the first interface, and a second interface, wherein the I/O module is further configured to send a first signal indicating the availability of the first process data to the control module via the second interface and/or to receive a second signal indicating the availability of the second process data from the control module via the second interface. The I/O module is further configured to cause the first interface to transition from a power saving mode, in which the first interface is not ready to receive data, to a communication mode, in which the first interface is ready to receive data, when the first interface is in the power saving mode and the second signal is received via the second interface. If the first interface transitions back to power saving mode, the I/O module can, when it no longer has any tasks to process, be put into a power saving mode in which essentially only the second interface is monitored.

In this regard, the term “module” can refer to a device which is configured to be electrically connected to another device in order to extend the capabilities of said other device, wherein both devices functionally form a unit. For example, two devices may form a functional unit if their internal cooperation is necessary to provide the required data and/or services and the recipient of the data and/or services is not required to have a part in the internal cooperation. It may be the case that both devices are configured to be connected to each other not only electrically but also mechanically, so that the devices form a unit not only functionally but also mechanically. In this context, the term “I/O module”, can refer to a device which is connected to the control module via a local bus and which connects, during operation, one or more field devices (via the local bus) with the control module and, potentially, (via the control module) with a higher-level control unit.

Furthermore, the term “control module”, can refer to a fieldbus coupler of a modular fieldbus node that is tasked with making data and/or services of the I/O modules connected to the fieldbus coupler available via a fieldbus to which the fieldbus coupler is connected. In this regard, the term “local bus”, can refer to a bus via which (only) the I/O modules connected to the fieldbus coupler are (directly) connected to one another or to the fieldbus coupler.

Furthermore, the term “first interface”, can refer to a bus interface which is configured to be connected to the local bus (or to generate the local bus) and to exchange (process) data with one or more other I/O modules and/or the fieldbus coupler. If the I/O module can be connected directly to the fieldbus, i.e., if the I/O module does not require a fieldbus coupler to communicate via the fieldbus, the term “first interface” can refer to a fieldbus interface, wherein the I/O module connects, during operation, one or more field devices (via the fieldbus) to the higher-level control unit. In this case, the control module or the functionality of the control module may be integrated into the higher-level control unit.

The I/O module may have several inputs and/or outputs which are configured to input state signals and/or output control signals (control voltages and/or control currents). The I/O module may be configurable with regard to deriving the first process data from the state signals or deriving the control signals from the second process data. In particular, the I/O module may be configured to derive the first process data sent to the control module from signals input via the input based on the configuration data or to derive signals to be output at the output from the second process data received by the control module based on the configuration data. The I/O module may also comprise a memory in which configuration data may be stored.

For example, the I/O module may comprise a processor and a memory in which configuration data is stored, wherein the processor is configured to derive the first process data sent to the control module from the signals input via the input based on the configuration data or to derive the signals to be output at the output from the second process data received by the control module based on the configuration data. The processor may further be configured to initiate a transmission of the first process data to the first interface or the first interface may be configured to initiate a transmission of the second process data to the processor.

Field devices that provide state signals or process control signals may be connected to the inputs and/or outputs. In this regard, the term “field device”, can refer to a sensor or an actuator which is (e.g., directly) connected to the I/O module (in terms of signaling). In this regard, the term “input” and “output”, can refer to an electrical connection. It may be provided that voltages and/or currents at inputs of an I/O module are generated by other devices, and voltages and/or currents at outputs of an I/O module are generated by the I/O module itself.

The I/O module may, for example, comprise a housing which is configured to serially connect the I/O module to another I/O module or to a fieldbus coupler. In this regard, the term “housing”, can refer to a structure made of a solid insulating material into which conductive structures are embedded, wherein the housing may be designed in such a way that an accidental contact with current-carrying conductors is essentially impossible. Furthermore, the term “serially connected/connecting”, can refer to the creation of a frictional or positive connection between housings, by means of which several I/O modules may be connected to one another in series. The housings may be designed in such a way that the wired transmission path is established by serially connecting the housings (without any further action).

Furthermore, the term “second interface”, can refer to an interface which is configured to be connected to a wired line and to detect a voltage on the wired line and to apply a voltage to the wired line. Alternatively, the second interface may be an optical interface or a wireless interface.

The I/O module may be configured to cause the first interface to transition from the power saving mode to the communication mode when the first interface is in the power saving mode and the first signal is sent via the second interface.

The I/O module may further comprise a first input configured to connect a first field device, wherein the I/O module may further be configured to derive the first process data from first field device signals received at the first input.

The I/O module may further comprise a second input configured to connect a second field device, and a first output configured to connect a third field device, wherein the I/O module may be further configured to derive third field device signals to be output at the first output from second field device signals received at the second input.

This means that the I/O module may be configured to execute tasks that can be completed locally (i.e. by the I/O module itself) and to wake up other components of the system only if the cooperation of said other components is necessary to execute the task. For example, the second field device may be a sensor, and the third field device may be an actuator, wherein the I/O module is configured to derive control signals controlling the actuator from sensor signals received from the sensor, without involving the control module (or another I/O module). If involvement of the control module (or another I/O module) is not necessary, the first interface may remain in power saving mode while the output is being output.

The I/O module may further comprise a second output configured to connect a fourth field device, wherein the I/O module may further be configured to derive field device signals to be output at the second output from the second process data.

For example, the first field device may be a sensor and the fourth field device may be an actuator, wherein the I/O module is configured to derive control signals controlling the actuator from sensor signals received from the sensor with the assistance, or under the control of, the control module or the higher-level control unit. Since this means that the involvement of the control module (or another I/O module) is required, the first interface must be placed in communication mode during execution.

Sending the first signal may include applying a particular voltage to a conductor connected to the second interface, and receiving the second signal may include detecting the particular voltage on the conductor connected to the second interface. The first signal and the second signal may be identical. For example, the first and second signals may be a specific voltage applied to the conductor.

A system may include a first I/O module and a second I/O module and a bus, wherein the first interfaces of the I/O modules are connected to the bus, and an electrical conductor, wherein the second interfaces of the I/O modules are connected to the electrical conductor.

The system may further comprise the control module, wherein the control module is configured to query the first I/O module and/or the second I/O module for the first process data in response to the first signal. The control module may act as a “master” and the I/O modules may act as “slaves”, wherein the data exchange is initiated and controlled by the master.

The control module may be further configured to derive the second process data from the first process data and to send the second process data to the first I/O module and/or the second I/O module. When deriving the second process data, the higher-level control unit may be involved, e.g., data received from the higher-level control unit may be taken into account.

The first I/O module and/or the second I/O module may further be configured to process the second process data and, after processing, to have the first interface transition from the communication mode to the power saving mode when, or as soon as, the second signal is no longer received via the second interface. If only one of the I/O modules needs to process the second process data, the first interfaces of all remaining I/O modules (or the I/O modules themselves) may immediately transition to power saving mode as soon as the second signal is no longer received via the second interface.

The system may further comprise a higher-level control unit, wherein the higher-level control unit is configured to cause the control module to transition from a sleep state to a wake state in response to an internal or external trigger mechanism, in which the control module is able to receive information from the higher-level control unit.

The higher-level control unit may be connected to several control modules that exchange data via the higher-level control unit.

The control module may be further configured to determine, based on the information, whether the first interfaces of the I/O modules are to be put into the communication mode and, if the first interfaces of the I/O modules are to be put into the communication mode, to transmit the second signal to the I/O modules via the conductor.

The system may further comprise another control module, wherein the higher-level control unit may be configured to receive the information from the other control module.

Furthermore, it is understood that all steps carried out when using the I/O device may, in principle, be features of a corresponding method and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of a fieldbus system;

FIG. 2 shows a schematic illustration of a fieldbus node of the fieldbus system shown in FIG. 1;

FIG. 3 illustrates the configuration of the fieldbus node shown in FIG. 2 by a computer connected to the fieldbus node;

FIG. 4 illustrates the operating mode of the interfaces of the fieldbus system shown in FIG. 1 when no communication via the first interfaces is taking place or is imminent;

FIG. 5 illustrates the sequence of operating modes of the interfaces of the fieldbus system shown in FIG. 1 when communication initiated by an I/O module occurs via the first interfaces;

FIG. 6 illustrates the sequence of operating modes of the interfaces of the fieldbus system shown in FIG. 1 when communication initiated by a control module occurs via the first interfaces;

FIG. 7 shows a modification of the fieldbus node; and

FIG. 8 illustrates a sequence of steps for exchanging data between an I/O module and the control module.

### DETAILED DESCRIPTION

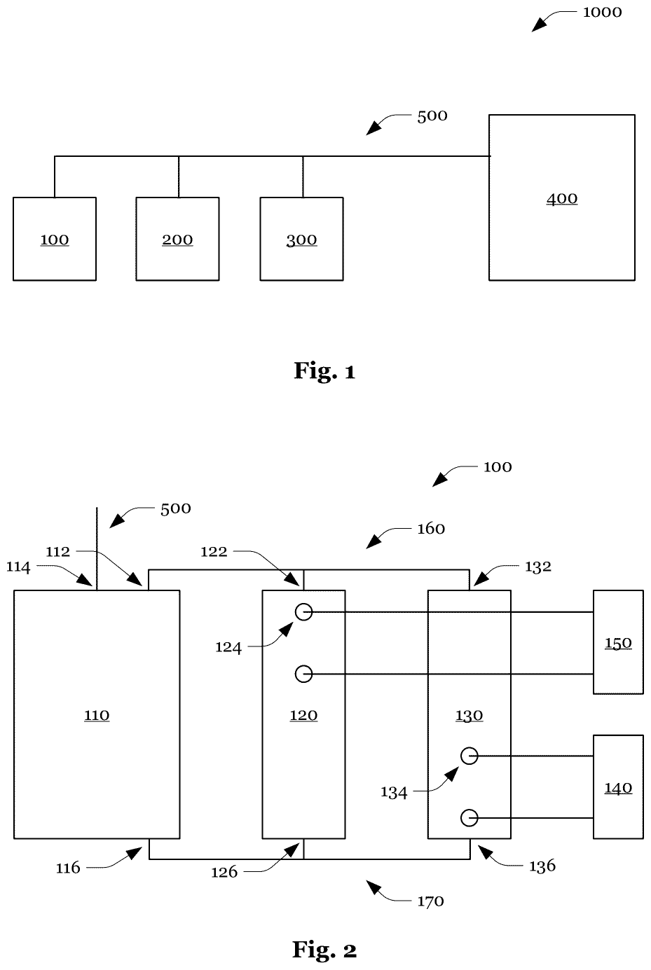

FIG. 1 shows a block diagram of fieldbus system 1000. Fieldbus system 1000 comprises fieldbus nodes 100, 200, 300 and 400, which are interconnected by fieldbus 500. Fieldbus node 400 is a higher-level control unit and may be used both for monitoring and for controlling an installation that is controlled by fieldbus system 1000. If the higher-level control unit 400 monitors an installation, the higher-level control unit 400 may cyclically or acyclically receive first process data describing the state of the installation from one or more of the fieldbus nodes 100, 200, and 300 and generate an alarm signal if the state of the installation deviates (substantially) from a desired/permitted state or state range. If the higher-level control unit 400 (not only monitors but also) controls the installation, the higher-level control unit 400 may cyclically or acyclically receive first process data from one or more of the fieldbus nodes 100, 200 and 300 and, taking the first process data into account, determine second process data which are transmitted to one or more of the fieldbus nodes 100, 200 and 300.

FIG. 2 shows a modular fieldbus node 100 formed of control module 110 and two I/O modules 120 and 130 which are serially connected to the control module 110 and to which a sensor 140 and an actuator 150 are connected. During operation, the I/O module 130 reads sensor signals via the input 134 and generates first process data from the sensor signals, which are transmitted to the control module 110 via the first interface 132 of the I/O module 130, the (local) bus 160, and the first interface 112 of the control module 110. Before the first process data are transmitted via the bus 160, the I/O module 130 indicates the availability of the first process data by applying a specific voltage (e.g. a High level) to the conductor 170 (e.g., a single-wire cable) which is connected to the second interface 136 of the I/O module 130.

When the control module 110 finds out about the availability of the first process data by detecting the specific voltage via the second interface 116 of the control module 110, the control module 110 causes the first interface 112 to transition from a power saving mode in which the first interface 112 is not ready to receive data to a communication mode in which the first interface 112 is ready to receive data, or, if the first interface 112 is already (or still) in the communication mode, the control module 110 causes the first interface 112 to remain in the communication mode. Depending on the configuration of the control module 110 and the type and/or content of the first data, the control module 110 may process the first data locally or forward it via the fieldbus interface 114 of the control module 110. The control module 110 may comprise a processor and a memory in which information regarding the configuration of the control module 110 is stored.

The information regarding the configuration of the control module 110 may, for example, indicate which or how many I/O modules 120, 130 are connected to the control module 110 and how the control module 110 should handle the first process data received. The control module 110 may, for example, be configured to process the first process data locally and/or to forward it (possibly in modified form) to the higher-level control unit 400 via the fieldbus interface 114 and the fieldbus 500. The higher-level control unit 400 (or the control module 110 in the case of local processing) may then generate the second process data taking into account the first process data.

The second process data generated by the higher-level control unit 400 may then be transmitted to the control module 110 via the fieldbus 500. The second process data transmitted to the control module 110 (or generated by the control module 110 in case of local processing) are then forwarded or transmitted (possibly in modified form) to the I/O module 120. The I/O module 120 receives the second process data and outputs control signals corresponding to the second process data at the output 124 to which the actuator 150 is connected. The communication of data between the components of the fieldbus system 1000 and the mapping of the sensor signals to the first process data and the mapping of the second process data to control signals may be adapted to different application scenarios by configuring the fieldbus node 100.

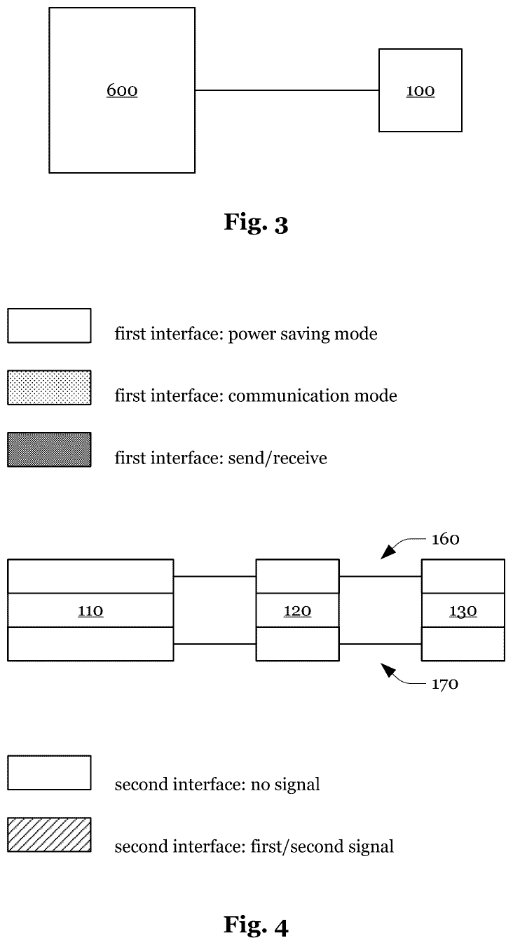

FIG. 3 shows a fieldbus node 100 and a computer 600 connected to the fieldbus node 100 (which may be, for example, a desktop, a laptop, a tablet, etc.), which is configured to effectuate the configuration of the I/O modules 120 and 130 of the fieldbus node 100. The computer 600 may serve solely or primarily for effectuating the configuration but may also perform other tasks (in addition to effectuating the configuration). In particular, the computer 600 may be part of the higher-level control unit 400 and, in addition to the configuration, also effectuate monitoring and/or control tasks. For example, the computer 600 may monitor the installation and be configured to transition from one operating mode to another operating mode if certain conditions are met (and to change or update the configuration, if necessary, as part of the transition).

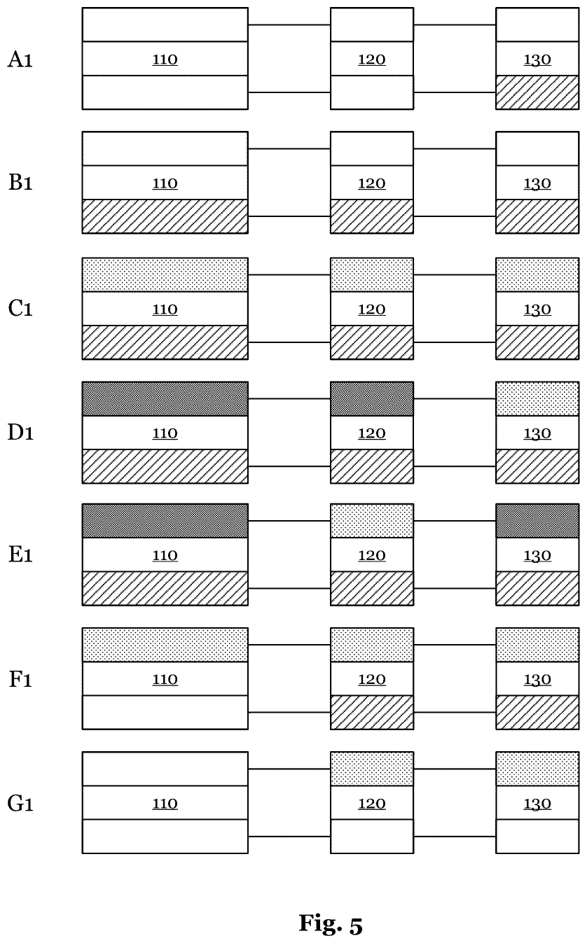

As schematically illustrated in FIG. 4, the components of the fieldbus node 100 may be in a power saving mode during phases in which no communication needs to take place via the bus 160 and may remain in the power saving mode until a second signal is received via the conductor 170 or an internal wake-up condition is met. If, as illustrated in FIG. 5, the I/O module 130 detects a wake-up condition in phase A1 (e.g., the reception of sensor signals from which first process data to be transmitted to the control module 110 are to be derived), the I/O module 130 outputs a first signal via the second interface 136 which indicates the availability of the first process data.

The first signal output via the second interface 136 is read in phase B1 by the I/O module 120 and the control module 110 via the second interfaces 126 and 116, respectively. In phase C1, the signal input via the second interfaces 126 and 116 causes the first interfaces 122 and 112, respectively, to transition from the power saving mode to the communication mode. At the same time, the first interface 132 transitions from power saving mode to communication mode. In phase D1, the control module 110 then queries the I/O module 120 for the availability of new process data. If the I/O module 120 has new process data, the I/O module 120 transmits the new process data to the control module 110 via the bus 160.

In phase E1, the control module 110 then queries the I/O module 130 for the availability of new process data. Since the I/O module 130 has new first process data, it transmits the new first process data to the control module 110 via the bus 160. After the I/O module 130 has transmitted the first process data to the control module 110 via the bus 160, the I/O module 130 stops outputting the first signal via the second interface 136. However, since the control module 110 derives second process data from the first process data and transmits the second process data to the I/O module 130 and outputs the second signal at the second interface 116 until the transmission is completed, the first interfaces 122 and 132 remain in communication mode.

After completion of the transmission of the second process data to the I/O module 130, the control module 110 checks whether further data is to be transmitted via the bus 160 and terminates the output of the second signal at the second interface 116 in phase F1, since (currently) no further data is to be transmitted via the bus 160. By terminating the output of the second signal at the second interface 116, the first interfaces 122 and 132 also transition to power saving mode and remain in this state throughout phase G1 until the second signal is received again via conductor 170 or an internal wake-up condition is met. In phases in which no events occur, not only the interfaces 122 and 132 but also all other components of the system that are not required to monitor conductor 170 may transition to power saving mode.

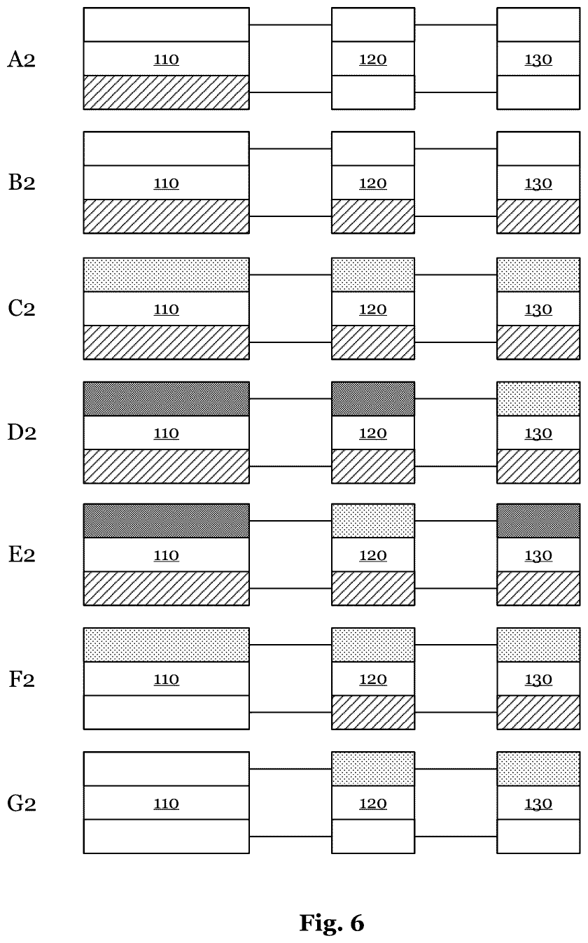

If, as illustrated in FIG. 6, the control module 110 detects a wake-up condition in phase A2 (e.g., the receipt of second process data from the higher-level control unit), the control module 110 outputs the second signal via second interface 116, which indicates the availability of the second process data. The second signal output via the second interface 116 is read in phase B2 by the I/O module 120 and the control module 130 via the second interfaces 126 and 136, respectively. In phase C2, the signal input via the second interfaces 126 and 136 causes the first interfaces 122 and 132, respectively, to transition from the power saving mode to the communication mode. At the same time, the first interface 112 transitions from power saving mode to communication mode. In phase D2, the control module 110 then queries the I/O module 120 for the availability of new process data. If the I/O module 120 has new process data, the I/O module 120 transmits the new process data to the control module 110 via bus 160.

In phase E2, the control module 110 transmits the second process data to the I/O module 130 and, if necessary, queries the I/O module 130 for the availability of new process data. If the I/O module 130 has new process data, the I/O module 130 transmits the new process data to the control module 110 via the bus 160. After completion of the transmission of the second process data to the I/O module 130, the control module 110 checks whether further data is to be transmitted via the bus 160 and terminates the output of the second signal at the second interface 116 in phase F2, since (currently) no further data is to be transmitted via the bus 160. By terminating the output of the second signal at the second interface 116, the first interfaces 122 and 132 also transition to power saving mode and remain in this state throughout phase G2 until the second signal is received again via conductor 170 or an internal wake-up condition is met.

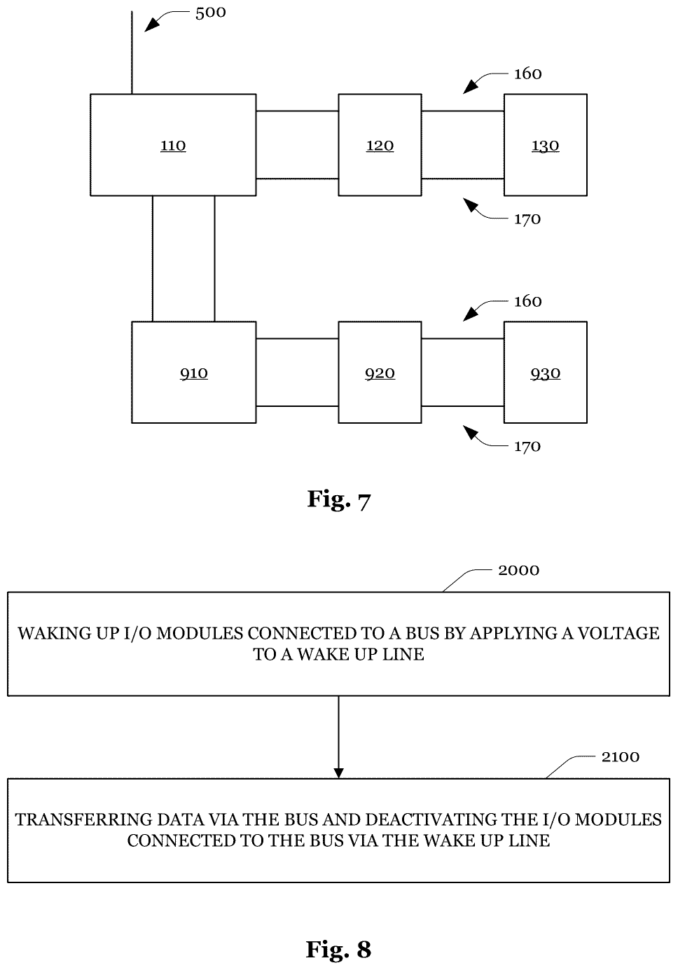

As illustrated in FIG. 7, by using an expander module 910, which is controlled by the control module 110 and takes the place of the control module 110 in respect to the I/O modules 120 and 130 with respect to communication with the I/O modules 920 and 930, a second communication branch may be set-up in a star-shaped topology, wherein the individual strands may be activated independently of one another.

FIG. 8 shows a flow chart of a process for exchanging data between the I/O module 130 and the control module 110. At step 2000, I/O modules 120 and 130 are woken up by applying a voltage to conductor 170. Then, at step 2100, data is transferred via the bus 160 and after the data transfer is completed, the I/O modules 120 and 130 are sent back to power saving mode via the wake-up line.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An input/output module comprising:
a first interface, wherein the I/O module is configured to send first process data to a control module via the first interface and/or to receive second process data from the control module via the first interface; and
a second interface, wherein the I/O module is further configured to send a first signal indicating availability of the first process data to the control module via the second interface and/or to receive a second signal indicating availability of the second process data from the control module via the second interface,
wherein the I/O module is configured to cause the first interface to transition from a power saving mode, in which the first interface is not ready to receive data, to a communication mode, in which the first interface is ready to receive data, when the first interface is in the power saving mode and the second signal is received via the second interface.

2. The I/O module according to claim 1, wherein the I/O module (130) is further configured to cause the first interface (132) to transition from the power saving mode to the communication mode when the first interface (132) is in the power saving mode and the first signal is sent via the second interface (136).

3. The I/O module according to claim 1, further comprising:
a first input configured to connect to a first field device,
wherein the I/O module is further configured to derive the first process data from first field device signals received at the first input.

4. The I/O module according to claim 3, further comprising:
a second input configured to connect a second field device; and
a first output configured to connect a third field device,
wherein the I/O module is further configured to derive third field device signals to be output at the first output from second field device signals received at the second input.

5. The I/O module according to claim 1, further comprising:
a second output configured to connect a fourth field device,
wherein the I/O module is further configured to derive field device signals to be output at the second output from the second process data.

6. The I/O module according to claim 1, wherein sending the first signal comprises applying a specific voltage to a conductor connected to the second interface, and wherein receiving the second signal comprises detecting the specific voltage at the conductor connected to the second interface.

7. A system comprising:
a first I/O module;
a second I/O module, the first and second I/O module being formed according to the I/O module according to claim 1; and
a bus connected to the first interfaces of the first and second I/O modules; and
a conductor connected to the second interfaces of the first and second I/O modules.

8. The system according to claim 7, further comprising:
a control module configured to query the first I/O module and/or the second I/O module for the first process data in response to the first signal.

9. The system according to claim 8, wherein the control module is further configured to derive the second process data from the first process data and to send the second process data to the first I/O module and/or the second I/O module.

10. The system according to claim 9, wherein the first I/O module and/or the second I/O module are further configured to process the second process data and, after processing, have the first interface transition from the communication mode to the power saving mode when, or as soon as, the second signal is no longer received via the second interface.

11. The system according to claim 7, further comprising:
a higher-level control unit configured to cause the control module to transition from a sleep state to a wake state in response to an internal or external trigger mechanism, in which the control module is able to receive information from the higher-level control unit.

12. The system according to claim 11, wherein the control module is further configured to determine, based on the information, whether the first interfaces of the first and second I/O modules are to be put into the communication mode and, if the first interfaces of the first and second I/O modules are to be put into the communication mode, to transmit the second signal to the first and second I/O modules via the conductor.

13. The system according to claim 11, further comprising:
a further control module, wherein the higher-level control unit is further configured to receive the information from the other control module.
